(19) United States
(12) Patent Application Publication
(10) Pub. No.: US 2011/0163287 A1
(43) Pub. Date: Jul. 7, 2011

(54) Safety barricade system

(76) Inventor: Samuel Joseph Massameno, Torrington, CT (US)

(21) Appl. No.: 12/655,682

(22) Filed: Jan. 4, 2010

(51) Int. Cl. E04H 17/16; G09F 7/00

(52) U.S. Cl. 256/19; 256/31; 256/21; 40/605

(57) ABSTRACT

The present invention is a strong, rigid, safety barricade system that is made of a material that is either corrugated or solid and can be assembled around a work or dangerous site to prevent or deter entry thereto and avoid resulting injury or interference with work. The safety barricade system consists of interlocking panels that attach to each other by sliding two, slotted, rigid flaps on the lateral end of one panel into the two slots that form the rigid flaps of another panel, and such panels are attached to an existing structure by use of a U-shaped rod that connects to a panel on one side and, by a suction cup, to the existing structure on the other. After interconnection, the panels are locked in place using a U-shaped interconnecting rod and an irreversible plastic “tie.” The barricade system is lightweight, easy to assemble and portable.

### CROSS-REFERENCE TO RELATED APPLICATIONS

None

### STATEMENT REGARDING FEDERALLY SPONSORED RESEARCH OR DEVELOPMENT

The invention that is the subject of this specification has not been made under federally sponsored research and development.

### REFERENCE TO SEQUENCE LISTING, TABLE, OR COMPUTER PROGRAM

This specification does not include reliance upon any information contained in a compact disc.

### BACKGROUND OF THE INVENTION

The invention that is the subject of this specification relates generally to methods and apparatuses used to block entry to a work area or an area that poses some danger of injury. Under prior art, boards, plywood, saw horses, pails, A-frame barricades, or other objects would be used to form a barrier to entrance into work or dangerous areas. These methods of preventing entry to a work or hazardous area were deficient for several reasons.

First, under prior art, the boards, plywood, A-frame barricades and other objects that would be used would not necessarily prevent human entry into the work or dangerous area because such items, unless they blocked the entire area, often allowed some access to the area, especially by small children. As a result, the prior art afforded inadequate protection from what could have been a substantial risk of physical injury.

Second, under prior art, the boards, plywood, saw horses, pails, A-frame structures and other objects that would be used to form a barrier to entrance into a work or dangerous area would be easily movable, not interlocked, and not affixed to anything, thus allowing entry into such area and possible, resulting injury.

Third, under prior art, even if the boards or other objects that would be used to form a barrier to entrance into a work or hazardous area were installed in such a way as to be fully effective at preventing human passage, they would not easily be installed or removed, requiring significant time, effort and resultant cost.

Fourth, under prior art, the boards or other objects that would be used to form a barrier to entrance into a work or hazardous area typically would not be suitable for outdoor use, being subject either to deterioration or movement with significant winds.

Fifth, under prior art, the boards or other objects that would be used to form a barrier to entrance into a work or hazardous area typically would not contain any written warning of danger or any universally recognized symbol warning of a danger from entry into such an area. The present invention would bear such a warning.

Finally, where the hazardous area involved in the prior art posed a risk of serious injury or death, such as an elevator shaft or an escalator pit, the protection afforded often was inadequate to assure substantial protection from such a risk.

### BRIEF SUMMARY OF THE INVENTION

The present invention relates to a strong, rigid, safety barricade system that can be assembled around a work site or an area of danger to prevent or deter entry thereto and avoid resulting injury, interference with work activity, and theft of or tampering with tools; the safety barricade system consists of interlocking panels, each in a substantially planar shape, that attach to each other by sliding two, slotted, rigid flaps on the lateral end of one panel into the two slots that form the rigid flaps of another panel, and such panels are attached to an existing structure by inserting one side of a metal, U-shaped rod into a channel of a panel that is corrugated, which channel is located at the upper corner of the lateral end of the panel that is closest to the existing structure; the other lateral end of the U-shaped rod is attached to a free-turning suction cup that attaches by suction to the molding of a door or passage way or to a wall of such existing structure. Each of the barricade panels has four slotted, rigid flaps, two on each lateral end, which allow interconnection of the panels by inserting the slotted portion of two flaps on the lateral end of one panel into the slotted portion of the two flaps on the lateral end of another panel. Each panel also has hand grip openings at the top and at both lateral ends. When the barricade panels are constructed of a corrugated, plastic-based material, they are, after interconnection, locked in place using a U-shaped interconnecting rod, the two ends of which are to be inserted in the selected channels at the top corners of the upper ends of the two interconnected panels, at locations that form the desired angle. When the barricade panels are constructed of a solid material, they are interconnected in the same manner as corrugated panels, except that they are locked in place at a selected angle using a U-shaped interconnecting rod, one end of which is inserted in the selected channel of a connecting bracket that is affixed to the top corner of one interconnected panel and the other end of such U-shaped interconnecting rod is inserted in the selected channel of a connecting bracket on the other interconnected panel, the selected channels of such brackets forming the desired angle. After the panels are interconnected with the U-shaped rod, a plastic irreversible “tie” device is wrapped around the panels' upper, interconnected flaps and the U-shaped rod and tightened so as to prevent separation of the panels and the U-shaped rod. To secure a corrugated barricade panel to an existing structure, one side of a U-shaped rod is placed in a corrugated channel at the top corner of the lateral end of the panel nearest to the existing structure or through a corrugated channel at the lower portion of the hand grip opening at the middle of the lateral end closest to the existing structure, and the other side of the U-shaped rod is attached to a free-turning suction cup, which is attached by suction to a flat door molding, trim piece, escalator side wall or any wall that is adjacent to any work or dangerous area. The panels that comprise the safety barricade system have an opening at the bottom that allows for insertion of a sandbag for weighting in case of exterior applications that could involve strong winds. Said panels also provide a written warning of danger, with universally recognized signage.

### BRIEF DESCRIPTION OF THE DRAWING

FIG. 1 depicts a standard safety barricade system that consists of two corrugated plastic-based panels, the sides of which that are depicted are the sides exposed to hazard or a work area, identified by the number 1. The rigid side flaps of the panels are identified by the number 2. The interconnected rigid side flaps are identified by the number 3. The U-shaped connecting rods with and without attached free-turning suction cups are identified by the number 4. The free-turning suction cups at one end of the U-shaped connecting rods are identified by the number 5. The hand grip openings on the top and the two sides are identified by the number 6. The weighted bottoms of the panels are identified by the number 7. The sand-bag openings at the bottom of the panels are identified by the number 8. The irreversible, plastic tie is identified by the number 9.

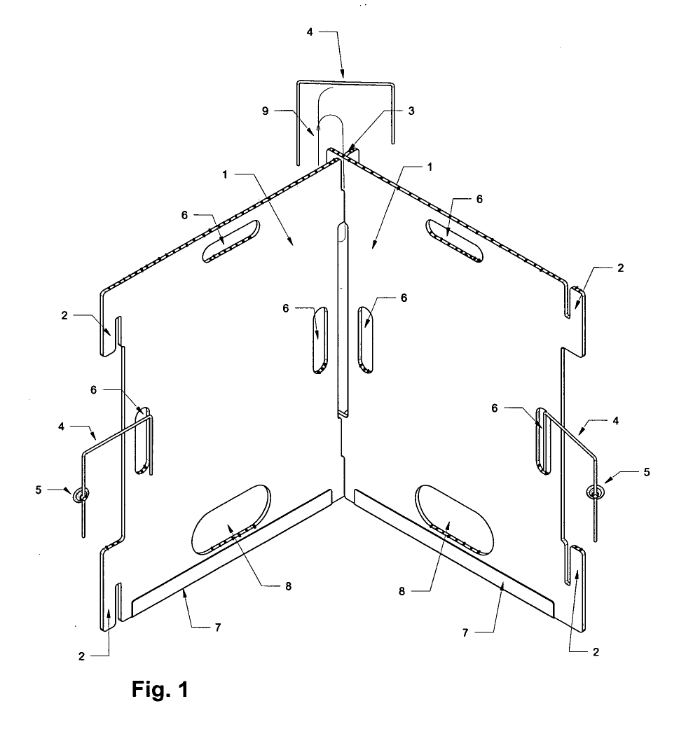

FIG. 2 depicts a version of the present invention that is a safety barricade system that consists of two solid panels, the sides of which that are depicted are the sides exposed to hazard or a work area, identified by the number 1. The rigid side flaps of the panels are identified by the number 2. The interconnected rigid side flaps are identified by the number 3. The U-shaped connecting rods with and without attached free-turning suction cups are identified by the number 4. The free-turning suction cups at one end of the U-shaped connecting rods are identified by the number 5. The interconnecting brackets are identified by the number 6. The hand grip openings on the top and the two sides are identified by the number 7. The sand-bag openings at the bottom of the panels are identified by the number 8. The irreversible, plastic tie is identified by the number 9.

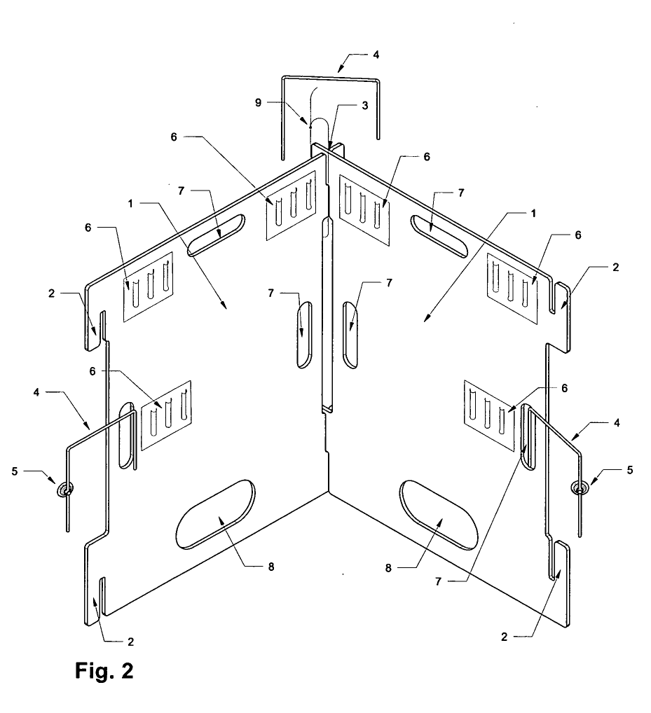

### DETAILED DESCRIPTION OF THE INVENTION

The present invention relates to a strong, rigid, safety barricade system that can be assembled around a work site or an area of danger to prevent or deter entry thereto and avoid resulting injury, interference with work activity, and theft of or tampering with tools; the safety barricade system consists of interlocking panels, each in a substantially planar shape, that attach to each other by sliding two, slotted, rigid flaps on the lateral end of one panel into the two slots that form the rigid flaps of another panel, and such panels are attached to an existing structure by inserting one side of a metal, U-shaped rod into a channel of a panel that is corrugated, which channel is located at the upper corner of the lateral end of the panel that is closest to the existing structure; the other lateral end of the U-shaped rod is attached to a free-turning suction cup that attaches by suction to the molding of a door or passage way or to a wall of such existing structure. The safety barricade system panels also provide a written warning of danger from entry, with universally recognized signage. Each of the barricade panels has four slotted, rigid flaps, two on each lateral end, which allow interconnection of the panels by inserting the slotted portion of two flaps on the lateral end of one panel into the slotted portion of the two flaps on the lateral end of another panel. Each panel also has hand grip openings at the top and at both lateral ends. When the barricade panels are constructed of a corrugated, plastic-based material, they are, after interconnection, locked in place using a U-shaped interconnecting rod, the two ends of which are to be inserted in the selected channels at the top corners of the upper ends of the two interconnected panels, at locations that form the desired angle. When the barricade panels are constructed of a solid material, they are interconnected in the same manner as corrugated panels, except that they are locked in place at a selected angle using a U-shaped interconnecting rod, one end of which is inserted in the selected channel of a connecting bracket that is affixed to the top corner of one interconnected panel and the other end of such U-shaped interconnecting rod is inserted in the selected channel of a connecting bracket on the other interconnected panel, the selected channels of such brackets forming the desired angle. After the panels are interconnected with the U-shaped rod, a plastic irreversible “tie” device is wrapped around the panels' upper, interconnected flaps and the U-shaped rod and tightened so as to prevent separation of the panels and the U-shaped rod. To secure a corrugated barricade panel to an existing structure, one side of a U-shaped rod is placed in a corrugated channel at the top corner of the lateral end of the panel nearest to the existing structure or through a corrugated channel at the lower portion of the hand grip opening at the middle of the lateral end closest to the existing structure, and the other side of the U-shaped rod is attached to a free-turning suction cup, which is attached by suction to a flat door molding, trim piece, escalator side wall or any wall that is adjacent to any work or dangerous area. To secure a solid barricade panel to an existing structure, a U-shaped rod is placed into a selected channel of a connecting bracket that is affixed to the top corner of the panel that is nearest to the existing structure, or to a selected channel of a connecting bracket that is located near the inner side of the lateral hand grip opening closest to the existing structure; and the other side of the U-shaped rod is attached to a free-turning suction cup, which is attached by suction to a flat door molding, trim piece, escalator side wall or any wall that is adjacent to any work or dangerous area. The disconnection of the panels at the conclusion of their use is achieved by cutting the plastic irreversible “tie” device at the top, interconnected corners of the connected panels and removing the U-shaped rods, and on panels connected to a structure, by breaking the suction of the suction cups and removing the rods and the cups attached thereto from the existing structure. An opening at the bottom of each panel is for the insertion on site of a sand-bag, to provide additional weighting of the panels. The approximate dimensions of the panels range from 36 inches in width by 42 inches in height to 72 inches in height, though such dimensions are not an integral part of said invention. A more substantial version of the invention involves the attachment of a weighting device to the bottom of each panel in the form of steel angle iron, or similar material, of appropriate size and weight, that is equipped with non-slide foam pads on the bottom to minimize slippage between the barricade and the floor upon which it rests.

We claim:

1. A strong, rigid, safety barricade system that can be assembled around a work site or an area of danger to prevent or deter entry thereto and avoid resulting injury, interference with work activity, and theft of or tampering with tools; the safety barricade system consists of interlocking panels, each in a substantially planar shape, that attach to each other by sliding two, slotted, rigid flaps on the lateral end of one panel into the two slots that form the rigid flaps of another panel, and such panels are attached to an existing structure by inserting one side of a metal, U-shaped rod into a channel of a panel that is corrugated, which channel is located at the upper corner of the lateral end of the panel that is closest to the existing structure; the other lateral end of the U-shaped rod is attached to a free-turning suction cup that attaches by suction to the molding of a door or passage way or to a wall of such existing structure. The safety barricade system panels also provide a written warning of danger from entry, with universally recognized signage. Each of the barricade panels has four slotted, rigid flaps, two on each lateral end, which allow interconnection of the panels by inserting the slotted portion of two flaps on the lateral end of one panel into the slotted portion of the two flaps on the lateral end of another panel. Each panel also has hand grip openings at the top and at both lateral ends. When the barricade panels are constructed of a corrugated, plastic-based material, they are, after interconnection, locked in place using a U-shaped interconnecting rod, the two ends of which are to be inserted in the selected channels at the top corners of the upper ends of the two interconnected panels, at locations that form the desired angle. When the barricade panels are constructed of a solid material, they are interconnected in the same manner as corrugated panels, except that they are locked in place at a selected angle using a U-shaped interconnecting rod, one end of which is inserted in the selected channel of a connecting bracket that is affixed to the top corner of one interconnected panel and the other end of such U-shaped interconnecting rod is inserted in the selected channel of a connecting bracket on the other interconnected panel, the selected channels of such brackets forming the desired angle. After the panels are interconnected with the U-shaped rod, a plastic irreversible “tie” device is wrapped around the panels' upper, interconnected flaps and the U-shaped rod and tightened so as to prevent separation of the panels and the U-shaped rod. To secure a corrugated barricade panel to an existing structure, one side of a U-shaped rod is placed in a corrugated channel at the top corner of the lateral end of the panel nearest to the existing structure or through a corrugated channel at the lower portion of the hand grip opening at the middle of the lateral end closest to the existing structure, and the other side of the U-shaped rod is attached to a free-turning suction cup, which is attached by suction to a flat door molding, trim piece, escalator side wall or any wall that is adjacent to any work or dangerous area. To secure a solid barricade panel to an existing structure, a U-shaped rod is placed into a selected channel of a connecting bracket that is affixed to the top corner of the panel that is nearest to the existing structure, or to a selected channel of a connecting bracket that is located near the inner side of the lateral hand grip opening closest to the existing structure; and the other side of the U-shaped rod is attached to a free-turning suction cup, which is attached by suction to a flat door molding, trim piece, escalator side wall or any wall that is adjacent to any work or dangerous area. The disconnection of the panels at the conclusion of their use is achieved by cutting the plastic irreversible “tie” device at the top, interconnected corners of the connected panels and removing the U-shaped rods, and on panels connected to a structure, by breaking the suction of the suction cups and removing the rods and the cups attached thereto from the existing structure. An opening at the bottom of each panel is for the insertion on site of a sand-bag, to provide additional weighting of the panels. The approximate dimensions of the panels range from 36 inches in width by 42 inches in height to 72 inches in height, though such dimensions are not an integral part of said invention. A more substantial version of the invention involves the attachment of a weighting device to the bottom of each panel in the form of steel angle iron, or similar material, of appropriate size and weight, that is equipped with non-slide foam pads on the bottom to minimize slippage between the barricade and the floor upon which it rests.

2. A strong, rigid, safety barricade system as described in claim 1, except that the barricade panels of which it consists are heavy duty and more substantial in that they include a weighting device located at the bottom of each panel in the form of steel angle iron, or similar material, of appropriate size and weight, that is equipped with non-slide foam pads on the bottom thereof to minimize slippage between the barricade panel and the floor upon which it rests.

3. A strong, rigid, safety barricade system as described in claim 1, except that the barricade panels of which it consists are made of a corrugated material, such as a plastic-based material, that allows for the insertion of the U-shaped rod in channels thereof at the top corners of each panel and at the lower portion of the lateral hand grip on each lateral end.

4. A strong, rigid, safety barricade system as described in claim 1, except that the barricade panels of which it consists are made of a solid, rigid material, such as a plastic-based or wood-based material, that are equipped with channeled connecting brackets, on the side facing the danger or work area, that are attached to the upper corners thereof and the inner side of the lateral hand grips.

5. A strong, rigid, safety barricade system, as described in claim 1 above, except that the dimensions of the substantially planar surface that comprises the barricade panels of which it consists vary according to the particular application thereof.

6. A strong, rigid, safety barricade system, as described in claim 1 above, except that the barricade panels of which it consists bear a written warning of danger, on the side away from the area of danger or work, which warning is accompanied by a universally recognized symbol warning of a danger.
